(19) United States
(12) Patent Application Publication
(10) Pub. No.: US 2012/0086272 A1
(43) Pub. Date: Apr. 12, 2012

(54) REMOTELY POWER-CONTROLLABLE POWER OUTLET DEVICE AND POWER OUTLET THEREOF

(76) Inventors: Wan-Tien Chen, Taipei (TW); Wei-Cheng Lin, Taipei (TW)

(21) Appl. No.: 13/252,338

(22) Filed: Oct. 4, 2011

(30) Foreign Application Priority Data
Oct. 7, 2010 (TW) 099134206

(51) Int. Cl. H02J 3/00; H02H 3/20; H02H 3/08

(52) U.S. Cl. 307/38

(57) ABSTRACT

A remotely power-controllable power outlet device has at least one power outlet and a remote control. Each of the at least one power outlet has at least one set of sockets formed through the power outlet, at least one power switch and a control circuit electrically connected with the at least one power switch. Each of the at least one power switch is mounted in a corresponding set of sockets. The control circuit is mounted in the power outlet, remotely receives a switching command having codes and a switching command corresponding to one set of sockets of the at least one set of sockets, and controls a corresponding power switch to switch power to the set of sockets in accordance with the power switching instruction. Accordingly, a single remote control can remotely power on or off electric appliances plugged in the at least one power outlets.

### BACKGROUND OF THE INVENTION

1. Field of the Invention

The present invention relates to a power outlet, and more particularly to a remotely power-controllable power outlet device having a power outlet and a remote control capable of remotely switching power supplied to the power outlet.

2. Description of the Related Art

Regular power outlets having multiple sets of sockets are available to be simultaneously plugged in by the plugs of various electric appliances. In particular, a power outlet in the form of an extension cord can transmit power to multiple sets of sockets at one end thereof from a distant wallmount power outlet, be connected to the AC mains, and plugged in by the other end of the power outlet. Despite being situated away from the wallmount power outlet, electric appliances can still acquire an operating power from the wallmount power outlet.

When intending to switch off power to such power outlets in use, users have to approach the power outlets to switch the power outlets off themselves. However, such power outlets are usually hidden behind large furniture for aesthetic concern or for simply avoiding being treaded on, and are thus not easily accessible when the users try to switch on or off the power outlets. Additionally, for such simple power outlets, power load information of the power outlets is not made known to the users. Accordingly, the power outlets fail to be controlled beforehand when the power consumption of the electric appliances plugged in the power outlets exceeds an upper load limit. In case of overloading of the power outlets, a power glitch may occur or, in the worse case, an explosion may occur, causing a fire and injuring people, and ending up with a catastrophe.

### SUMMARY OF THE INVENTION

A first objective of the present invention is to provide a remotely power controllable power outlet device and a power outlet thereof capable of remotely setting an upper load limit of the power outlet and switching on or off the power outlet, cutting off power supplied to sockets of the power outlet when a load of the power outlet exceeds the upper load limit, and significantly enhancing operational convenience and safety of the power plug in use.

To achieve the foregoing objective, the remotely power controllable power outlet device has at least one power outlet and a remote control. Each of the at least one power outlet has a casing, at least one set of sockets, at least one power switch and a control circuit. The at least one set of sockets is formed through the casing. Each of the at least one power switch is mounted in and electrically connected with one set of sockets of the at least one set of sockets. The control circuit is mounted in the power outlet, remotely receives a power switching instruction having codes and a switching command corresponding to the power outlet and one set of sockets of the at least one set of sockets, controls a corresponding power switch to switch power of the set of sockets in accordance with the power switching instruction.

The remote control has a body, multiple buttons and a remote control circuit. The buttons are mounted on the body. The remote control circuit is mounted inside the body, is built in with at least one power outlet code respectively corresponding to the at least one power outlet and at least one socket code respectively corresponding to the at least one set of sockets, and wirelessly transmits the power switching instruction generated by the buttons and having the codes respectively corresponding to one of the at least one power outlet code and one of the at least one set of sockets to the at least one power outlet.

As each set of sockets has a power switch mounted therein, when receiving a switching command from the remote control, the control circuit can switch on or off a corresponding power switch electrically connected with the set of sockets indicated by the codes in the switching command. Accordingly, users can employ a single remote control to power on or off electric appliances plugged in the at least one power outlet, thereby reducing the number of remote controls for various electric appliances.

A second objective of the present invention is to provide a power outlet device having power monitoring function.

To achieve the foregoing objective, an input device is mounted on the power outlet and serves to input a power safety parameter of the control circuit, and the control circuit further has a power measuring module for measuring a piece of power load information of one of the at least one power outlet, and determining if a power load contained in the power load information exceeds the power safety parameter, so that if positive, the currently active power switch is deactivated and no power is supplied to a corresponding set of sockets. Therefore, an active protection mechanism for power safety is established. Additionally, the control circuit further has an alarm to alert users when the control circuit detects that the power load exceeds a power safety parameter.

Preferably, the power load information measured by the power measuring module has voltage, current and consumed power.

A third objective of the present invention is to provide a power outlet capable of displaying a power load of the power outlet device.

To achieve the foregoing objective, the control circuit further has a display displaying a display signal generated by the control circuit after the control circuit acquires the power load information from the power measuring module.

Other objectives, advantages and novel features of the invention will become more apparent from the following detailed description when taken in conjunction with the accompanying drawings.

### BRIEF DESCRIPTION OF THE DRAWINGS

FIG. 1 is a functional diagram of a remotely controllable power outlet in accordance with the present invention;

FIG. 2 is a functional diagram of a remote control in accordance with the present invention;

FIG. 3 is a flow chart in accordance with the present invention for illustrating that the remote control in FIG. 2 performs a remote power load setting process of the power outlet in FIG. 1;

FIG. 4 is a flow chart in accordance with the present invention for illustrating that the power outlet in FIG. 1 performs the power load setting process based on an instruction from the remote control in FIG. 2;

FIG. 5 is a flow chart in accordance with the present invention for illustrating that the power outlet in FIG. 1 performs a power monitoring process;

FIG. 6 is a flow chart in accordance with the present invention for illustrating that the remote control in FIG. 2 performs a remote socket switching process;

FIG. 7 is a flow chart in accordance with the present invention for illustrating that the power outlet in FIG. 1 performs a socket switching process;

FIG. 8 is a flow chart in accordance with the present invention for illustrating that the power outlet in FIG. 1 performs an inputted outlet power load setting process;

FIG. 9 is a flow chart in accordance with the present invention for illustrating that the power outlet in FIG. 1 performs an inputted socket switching process; and

FIG. 10 is an operational schematic view of a remotely power controllable power outlet device in accordance with the present invention.

### DETAILED DESCRIPTION OF THE INVENTION

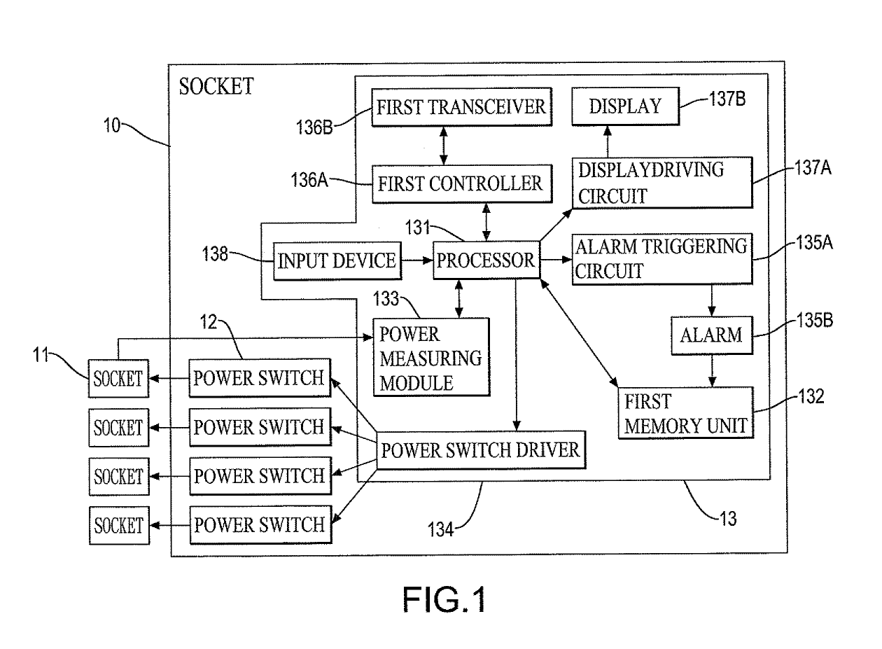

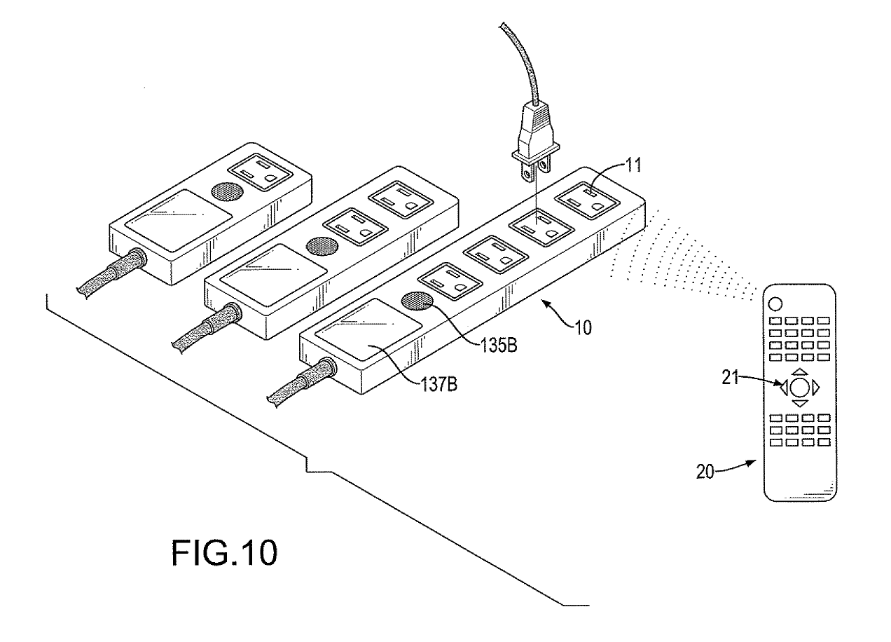

With reference to FIGS. 1 to 10, a remotely power controllable power outlet device and a remotely controllable power outlet in accordance with the present invention are shown. With further reference to FIGS. 1 and 10, the power outlet device has at least one power outlets 10 and a remote control 20. In the present embodiment, the remotely power controllable power outlet device has three power outlets 10.

Each of the at least one power outlet 10 has a casing 14, at least one set of sockets 11, at least one power switch 12 and a control circuit 13, and serves to supply power to at least one electric appliance when a power plug of the electric appliance is plugged in a corresponding set of sockets 11. The at least one set of sockets 11 is formed through the casing 14. In the present embodiment, the three power outlets 10 respectively have one set of sockets 11, two sets of sockets 11 and four sets of sockets 11. Each of the at least one power switch 12 is mounted in and is electrically connected with one set of sockets 11 of the at least one set of sockets 11. The control circuit 13 is mounted in the power outlet 10, is electrically connected with each of the at least one power switch 12, and serves to wirelessly receive a power switching instruction having a power outlet code, a socket code and a switching command corresponding to one of the at least one power outlet 10 and one set of sockets 11 of the at least one set of sockets 11, and controlling a corresponding power switch 12 to switch power of the set of sockets 11 in accordance with the switching command of the power switching instruction. Specifically, each of the at least one power outlet 10 receives the power switching instruction, and then the control circuit 13 of the power outlet 10 checks whether the power outlet code matches that of the power outlet 10. If so, the control circuit 13 further switches one of the at least one power switch 12 corresponding to the socket code of the power switching instruction according to the switching command of the power switching instruction.

The control circuit 13 has a processor 131, a first memory unit 132, a power measuring module 133, a power switch driver 134, an alarm triggering circuit 135A, an alarm 135B, a first controller 136A, a first transceiver 136B, a display driving circuit 137A, a display 137B and an input device 138. The first memory unit 132 is electrically connected with the processor 131. The power measuring module 133 is electrically connected with the processor 131 and the at least one set of sockets 11. The power switch driver 134 is electrically connected with the processor 131 and the at least one power switch 12. The alarm triggering circuit 135A is electrically connected with the processor 131. The alarm 135B is electrically connected with the alarm triggering circuit 135A. The wireless controller 136A is electrically connected with the processor 131. The first transceiver 136B is electrically connected with the first controller 136A. The display driving circuit 137A is electrically connected with the processor 131. The display 137E is electrically connected with the display driving circuit 137A. The input device 138 is electrically connected with the processor 131.

The processor 131 is built in with an outlet power load setting process, a power monitoring process, a socket switching process, an inputted outlet power load setting process and an inputted socket switching process. The first memory unit 132 is stored with power load information and a power safety parameter. The power load information includes voltage, current, consumed power and the like. The power measuring module 133 serves to measure a piece of power load information of the power outlet, and transmits the power load information to the processor 131 to determine if a power load contained in the power load information exceeds the power safety parameter. If positive, the processor directly controls the power switch driver 134 to deactivate each of the at least one currently active power switches 11 and cut off power to the electric appliance plugged in the at least one set of sockets 11 respectively connected with the at least one deactivated power switch 12, thereby actively ensuring safe use of electricity. Meanwhile, the alarm 135B is activated through the alarm triggering circuit 135A to remind users. The first transceiver 136B may follow a wireless communication protocol such as WiFi, Bluetooth, ZigBee or infrared communication. After the control circuit 13 acquires a piece of power load information from the power measuring module 133, a display signal is generated and transmitted to the display driving circuit 137A by the control circuit 13 to drive the display 137B to display. The input device 138 is mounted on the casing 14 of the power outlet 10, serves to input the power safety parameter of the control circuit 13 and can be integrated with the display 137B to become a touch panel.

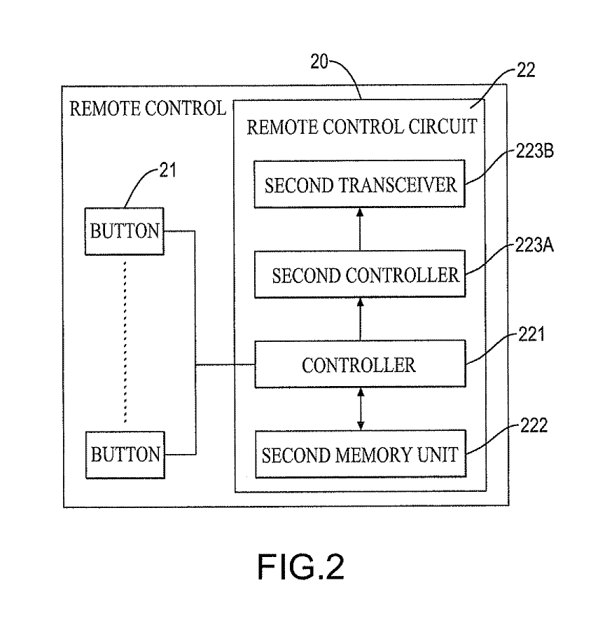

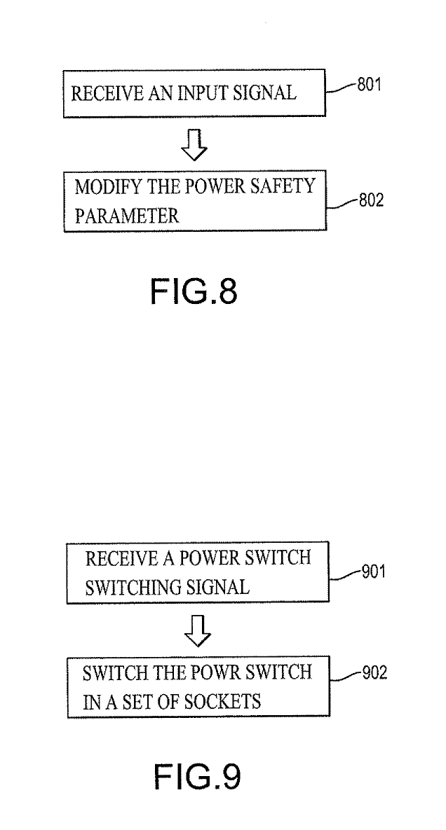

With further reference to FIGS. 2 and 8, the remote control 20 has a body 23, multiple buttons 21 and a remote control circuit 22. The buttons 21 are mounted on the body 23. The remote control circuit 22 is mounted inside the body 23 and has a controller 221, a second memory unit 222, a second controller 223A and a second transceiver 223B. The second memory unit 222 is electrically connected with the controller 221. The second controller 223A is electrically connected with the controller 221. The second transceiver 223B is electrically connected with the second controller 223A. The controller 221 is built in with a remote outlet power load setting process and a remote socket switching process. The second memory unit 222 is built in with power outlet codes and socket codes. The power outlet codes respectively correspond to the at least one power outlet 10, and the socket codes respectively correspond to the at least one set of power plugs 11. The second transceiver 223B follows a wireless communication protocol such as WiFi, Bluetooth, ZigBee, infrared communication or the like. The controller 221 transmits an activation command containing the power outlet code and the socket code outputted by the buttons 21 to a corresponding power outlet 10 through the second transceiver 223B.

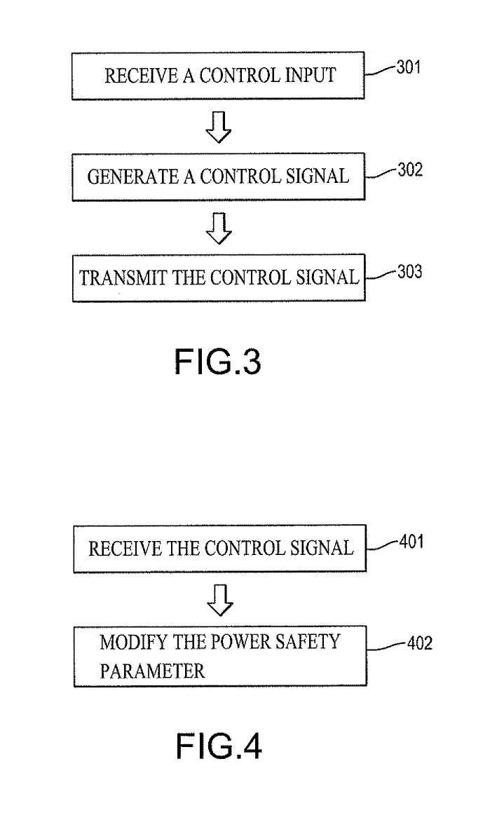

With further reference to FIG. 3, the remote control 20 works in connection with the power outlet 10 having four sets of sockets to perform the remote power load setting process. The remote power load setting process has the following steps of:

receiving a control input 301; the remote control 20 receives the control input inputted through the buttons 21 and sends the control input to the controller 221;

generating a control signal 302; the controller 221 generates a corresponding control signal in accordance with the control input; and

transmitting the control signal 303; the controller 221 drives the second transceiver 223B through the second controller 223A to transmit the control signal to a corresponding power outlet 10.

With further reference to FIG. 4, the power outlet 10 having four sets of sockets 11 performs the outlet power load setting process in accordance with the control signal sent from the remote control 20. The outlet power load setting process has the following steps of:

receiving the control signal 401; after receiving the control signal, the first transceiver 136B transmits the control signal to the processor 131 through the first controller 136A; and

modifying the power safety parameter 402; the processor 131 modifies the power safety parameter stored in the first memory unit 132 in accordance with the control signal;

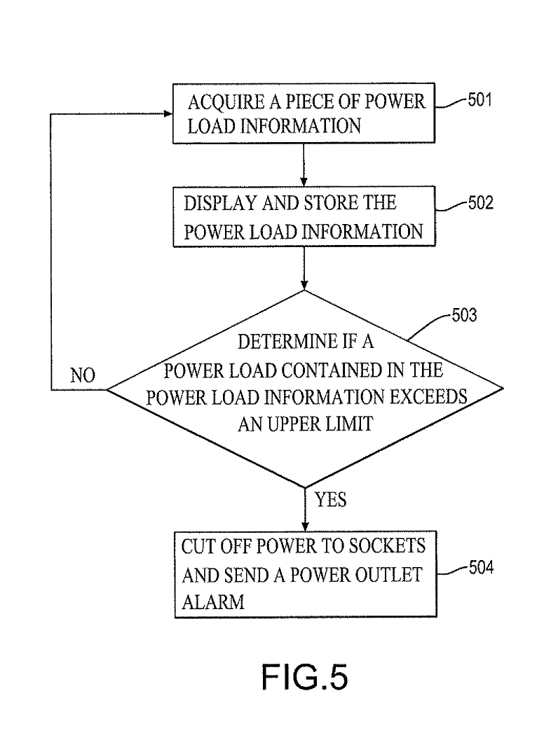

With further reference to FIG. 5, the power outlet 10 having four sets of sockets 11 performs the power monitoring process. The power monitoring process has the following steps of:

acquiring a piece of power load information 501; the processor 131 acquires the power load information from the power measuring module 133. The power load information includes voltage, current and the like;

displaying and storing the power load information 502; after acquiring the power load information, the processor 131 calculates statistical information with the voltage and the current indicated in the power load information, stores the statistical information in the first memory unit 132, generates a display signal, and sends the display signal to the display driving circuit 137A to drive the display 137 to display;

determining if a power load contained in the power load information exceeds an upper limit 503; the processor 131 reads the power safety parameter stored in the first memory unit 132 and determines if the power load exceeds an upper limit of the power safety parameter; if positive, performs next step; otherwise, resumes the step of acquiring a piece of power load information 501;

cutting off power to sockets and sending a power outlet alarm 504; after the processor 131 determines that a power load contained in the power load information exceeds the upper limit of the power safety parameter, a power cutoff time is set up in accordance with a formula for determining an over-voltage cutoff time or an over-current cutoff time. When the power cutoff time is up, power supplied to the at least one set of sockets 11 through the at least one power switch 12 is terminated, and an alarm signal is generated and sent to the alarm triggering circuit 135A to drive the alarm 135B to raise an alarm.

After the processor 131 determines that the voltage indicated in the power load information exceeds the upper limit of the power safety parameter, the power cutoff time is calculated by the following formula for determining the over-voltage cutoff time:

T₀=(1/(k3×(m3×V))⊕(1/k1×(m×1n(m1×1n(h2×I)))

where
T₀ represents the power cutoff time of one set of sockets 11;
m1 and m3 represent rating coefficients;
I represents the detected current in the power load information;
V represents the detected voltage in the power load information; and
⊕ represents the smaller value of (1/(k3×(m3×V)) and (1/k1×(m1×1n(m1×1n(h2×I))))

After the processor 131 determines that the current as indicated in the power load information exceeds the upper limit of the power safety parameter, the power cutoff time is calculated by the following formula for determining the over-current cutoff time:

T₁=I(k1×m1×1n(h1×I))

where
T₁ represents the power cutoff time of one set of sockets 11;
m1 represents a rating coefficient;
k1 represents a trip delayed time modifier; and

I represents the detected current in the power load information.

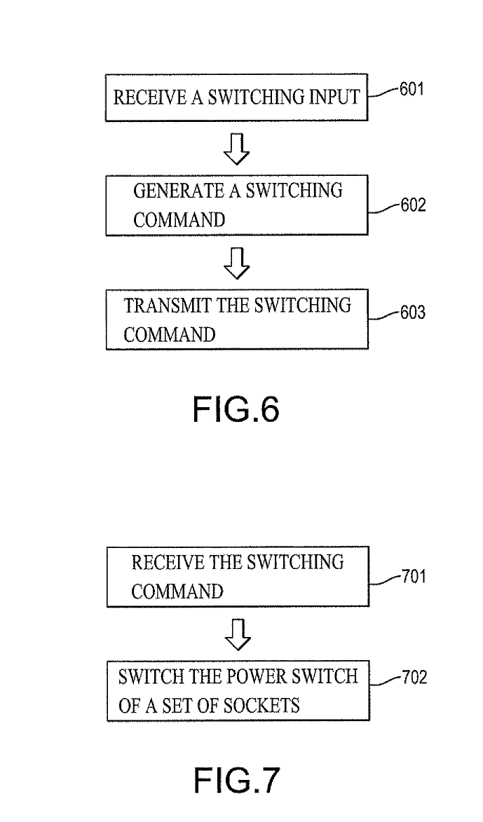

With further reference to FIG. 6, the remote control 20 performs the remote socket switching process. The remote socket switching process has the following steps of:

receiving a switching input 601; after receiving the switching input from the buttons 21, the remote control 20 transmits the switching input to the controller 221;

generating a switching command 602; the controller 221 generates a switching command in accordance with the switching input; and

transmitting the switching command 603; the controller 221 drives the second transceiver 223B through the second controller 223A to transmit the switching command to the power outlet 10.

With reference to FIG. 7, the power outlet 10 performs the socket switching process in accordance with the switching command from the remote control 20. The socket switching process has the following steps of

receiving the switching command 701; after receiving the switching command, the first transceiver 136B transmits the switching command to the processor 131; and

switching the power switch of a set of sockets 702; the processor 131 switches the power switch 12 of a corresponding set of sockets 11 in accordance with the switching command.

With reference to FIG. 8, the inputted outlet power load setting process is performed by the power outlet 10, and has the following steps of:

receiving an input signal 801; after receiving the input signal, the input device 138 of the power outlet 10 transmits the input signal to the processor 131; and

modifying the power safety parameter 802; the processor 131 modifies the power safety parameter stored in the first memory unit 132 in accordance with the input signal.

With reference to FIG. 9, the inputted socket switching process is performed by the at least one power outlet 10, and has the following steps of:

receiving a power switch switching signal 901; after receiving the power switch switching signal, the input device 138 transmits the power switch switching signal to the processor 131; and

switching the power switch in a set of sockets 902; the processor 131 switch the power switch 12 electrically connected with the set of sockets in accordance with the switching signal.

With further reference to FIG. 10, the present invention can wirelessly set up an upper load limit of one of the power outlets 10 and switch the power outlet 10 on or off through the remote control 20. When the power load of the power outlet 10 exceeds the preset upper load limit, the present invention automatically cuts off the power to the corresponding set of sockets 11, thereby significantly enhancing operational convenience and safety of the power outlet 10.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A remotely power controllable power outlet device, comprising:
at least one power outlet, each of the at least one power outlet having:
a casing;
at least one set of sockets formed through the casing;
at least one power switch, each of the at least one power switch mounted in the casing and electrically connected with one set of sockets of the at least one set of sockets; and
a control circuit mounted in the casing, remotely receiving a power switching instruction having a socket code and a switching command corresponding to one of the at least one power outlet and one set of sockets of the at least one set of sockets, and controlling a corresponding power switch to switch power of the set of sockets in accordance with the power switching instruction; and
a remote control having:
a body;
multiple buttons mounted on the body; and
a remote control circuit mounted inside the body, built in with at least one power outlet code respectively corresponding to the at least one power outlet and the at least one socket code respectively corresponding to the at least one set of sockets, and wirelessly transmitting the power switching instruction generated by the buttons and further having the power outlet code, wherein each of the at least one power outlet receives the power switching instruction, and then the control circuit of the power outlet checks whether the power outlet code is matched; if so, the control circuit further switches one power switch corresponding to the socket code of the power switching instruction according to the switching command of the power switching instruction.

2. The remotely power controllable power outlet device as claimed in claim 1, wherein the control circuit of each of the at least one power outlet has:
a processor;
a power switch driver electrically connected with the processor and the at least one power switch;
a first controller electrically connected with the processor; and
a first transceiver electrically connected with the first controller.

3. The remotely power controllable power outlet device as claimed in claim 2, wherein the control circuit of each of the at least one power outlet further has:
an input device mounted on the casing of the power outlet, and serving to input a power safety parameter of the control circuit;
a first memory unit electrically connected with the processor and storing power load information and the power safety parameter; and
a power measuring module electrically connected with the processor, serving to measure a piece of power load information of one of the at least one power outlet, and transmits the power load information to the processor to determine if a power load contained in the power load information exceeds the power safety parameter, so that if positive, the processor directly deactivates the currently active power switch and cuts off power to a corresponding set of sockets through the power switch.

4. The remotely power controllable power outlet device as claimed in claim 3, wherein the control circuit of each of the at least one power outlet further has an alarm triggered by the control circuit when the control circuit detects that the power load exceeds the power safety parameter.

5. The remotely power controllable power outlet device as claimed in claim 1, wherein the control circuit of each of the at least one power outlet further has:
an input device mounted on the power outlet, and serving to input a power safety parameter of the control circuit;
a first memory unit electrically connected with the processor and storing power load information and the power safety parameter; and
a power measuring module electrically connected with the processor, serving to measure a piece of power load information of one of the at least one power outlet, and transmits the power load information to the processor to determine if a power load contained in the power load information exceeds the power safety parameter, so that if positive, the processor directly deactivates the currently active power switch and cuts off power to a corresponding set of sockets through the power switch.

6. The remotely power controllable power outlet device as claimed in claim 1, wherein the power load information includes voltage, current and consumed power.

7. The remotely power controllable power outlet device as claimed in claim 1, wherein the control circuit of each of the at least one power outlet further has a display displaying a display signal generated by the control circuit after the control circuit acquires the power load information from the power measuring module.

8. The remotely power controllable power outlet device as claimed in claim 7, wherein the remote control circuit is built in with a remote outlet power load setting process having steps of:
receiving a control input, wherein the remote control receives the control input inputted through the buttons and sends the control input to the controller;
generating a control signal, wherein the controller generates a corresponding control signal in accordance with the control input; and
transmitting the control signal, wherein the remote control circuit transmits the control signal to a corresponding power outlet.

9. The remotely power controllable power outlet device as claimed in claim 8, wherein the processor is built in with an outlet power load setting process having steps of:
receiving the control signal, wherein the first transceiver transmits the control signal to the processor through the first controller after receiving the control signal; and
modifying the power safety parameter, wherein the processor modifies the power safety parameter stored in the first memory unit in accordance with the control signal.

10. The remotely power controllable power outlet device as claimed in claim 9, wherein the processor is further built in with a power monitoring process having steps of:
acquiring a piece of power load information, wherein the processor acquires the power load information from the power measuring module;
displaying and storing the power load information, wherein after acquiring the power load information, the processor stores the power load information in the first memory unit, generates and sends a display signal to the display for displaying;
determining if a power load contained in the power load information exceeds an upper limit, wherein the processor reads the power safety parameter stored in the first memory unit and determines if the current power load of the power outlet exceeds an upper limit of the power safety parameter; if positive, performs next step; otherwise, resumes the step of acquiring a piece of power load information;
cutting off power to sockets and sending a power outlet alarm, wherein after the processor determines that the power load of the power outlet exceeds the upper limit of the power safety parameter, a power cutoff time is set up in accordance with a formula for determining an over-voltage cutoff time or an over-current cutoff time, when the power cutoff time is up, power supplied to the at least one set of sockets through the at least one power switch is terminated, and an alarm signal is generated and sent to the alarm to issue an alarm.

11. The remotely power controllable power outlet device as claimed in claim 10, wherein the formula for determining an over-voltage cutoff time is expressed by:
T₀=(l/(k3×(m3×V))⊕(1/k1×(m1×1n(m1×1n(h2×I))))
where
T₀ represents the power cutoff time of one set of sockets;
m1 and m3 represent rating coefficients;
I represents the detected current in the power load information;
V represents the detected voltage in the load power load information; and
⊕ represents the smaller value of (1/(k3×(m3×V)) and (1/k1×(m1×1n(m1×1n(h2×I))))

12. The remotely power controllable power outlet device as claimed in claim 11, wherein the formula for determining an over-current cutoff time is expressed by:
T₁=1/(k1×m1×1n(h1×I))
where
T₁ represents the power cutoff time of one set of sockets;
m1 represents a rating coefficient;
k1 represents a trip delayed time modifier; and
I represents the detected current in the power load information.

13. The remotely power controllable power outlet device as claimed in claim 12, wherein the remote control circuit is built in with a remote socket switching process having steps of:
receiving a switching input, wherein after receiving the switching input from the buttons, the remote control transmits the switching input to the remote control circuit;
generating an activation command, wherein the remote control circuit generates an activation command in accordance with the switching input; and
transmitting the activation command, wherein the remote control circuit transmits the activation command to the power outlet.

14. The remotely power controllable power outlet device as claimed in claim 13, wherein the processor is built in with a socket switching process having steps of:
receiving the switching signal, wherein after receiving the activation command, the first transceiver transmits the activation command to the processor; and
switching the power switch of a set of sockets, wherein the processor switches the power switch of a corresponding set of sockets in accordance with the activation command,

15. The remotely power controllable power outlet device as claimed in claim 14, wherein the processor is built in with an inputted outlet power load setting process having steps of:
receiving an input signal, wherein after receiving the input signal, the input device of a corresponding power outlet transmits the input signal to the processor; and
modifying the power safety parameter, wherein the processor modifies the power safety parameter stored in the first memory unit in accordance with the input signal,

16. The remotely power controllable power outlet device as claimed in claim 15, wherein the processor is built in with an inputted socket switching process having steps of:
receiving a power switch switching signal, wherein after receiving the power switch switching signal, the input device transmits the power switch switching signal to the processor; and
switching the power switch in a set of sockets, wherein the processor switches the corresponding power switch of a set of sockets on or off in accordance with the switching signal.

17. The remotely power controllable power outlet device as claimed in claim 16, wherein the first transceiver follows WiFi wireless communication standard.

18. The remotely power controllable power outlet device as claimed in claim 16, wherein the first transceiver follows Bluetooth wireless communication standard.

19. The remotely power controllable power outlet device as claimed in claim 16, wherein the first transceiver follows ZigBee wireless communication standard,

20. The remotely power controllable power outlet device as claimed in claim 16, wherein the first transceiver follows infrared wireless communication standard.
